(19) United States
(12) Patent Application Publication
(10) Pub. No.: US 2008/0032136 A1
(43) Pub. Date: Feb. 7, 2008

(54) Product Comprising A Cover Layer And A Moulding Layer

(76) Inventors: Klaus Vissing, Morsum (DE); Volkmar Stenzel, Thedinghausen (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/597,599

(22) PCT Filed: May 24, 2005
(86) PCT No.: PCT/EP05/52366

§ 371 Date: Jul. 17, 2007

(30) Foreign Application Priority Data
May 27, 2004 (DE) 10 2004 026 479.1

(51) Int. Cl. B29C 33/38

(52) U.S. Cl. 428/411.1; 264/220; 427/133

(57) ABSTRACT

The invention relates to a product (11) with a laminated system (13; 15) consisting of at least one covering layer (15) and a moulding layer (13) arranged between the covering layer (15) and the product (11), wherein the moulding layer (13) is a plasma-polymeric layer that moulds the contours of the product (11) and adheres more firmly to the covering layer (15) than to the product (11). It further relates to a process for producing such a product (11) with a laminated system and to a process for producing a moulding negative and to a process for producing a positive model of (i) parts of the surface or (ii) the surface of a product.

The invention relates to a product with a laminated system consisting of at least one covering layer and a moulding layer arranged between the covering layer and the product, to a process for producing such a product with a laminated system, and also to a process for producing a moulding negative and to a process for producing a positive model of (i) parts of the surface or (ii) the surface of a product.

In many cases the moulding of surfaces is effected by casting. In this connection it is desirable, as a rule, that the master/original is moulded in a manner that is as dimensionally faithful as possible and accurate in every detail. In addition, it is often desirable that the results of moulding are given protection on their surface, for instance by virtue of a protective layer. For the purpose of casting, use is made predominantly of highly fluid polymeric materials that cure on the surface to be cast. The casting compound has to be capable of being removed from the moulded product easily after curing, in which connection this removal should be effected in as residue-free a manner as possible. Therefore the casting compound should possess properties in relation to the surface of the product to be moulded that enable/facilitate a separation of the casting compound from said product (dehesive properties). Accordingly, for the purpose of producing leather imitations, for example, in many cases use is made of casting compounds that are applied onto the surface of leather, are cured thereon, and are then separated from the leather, so that the surface of the then cured casting compound represents a negative of the moulded (original) leather surface.

The stated demands made upon the moulding material greatly restrict the number of materials known from the state of the art that can be used with good results. In many cases, contemporary casting compounds suffer, inter alia, from the fact that they can change their shape via a ‘flow’ (e.g. in the event of mechanical loading), and from the fact that they are too soft (lack of mechanical stability) or possess a specific structure, so that the original structure (where appropriate, nanostructure) of the originals is reproduced in altered manner. Also a problem is a residue-free separation from the surface to be moulded, particularly in the case of the moulding of nanostructures and microstructures. Further problems may be that the materials possess inadequate thermal stability for some applications, are not sufficiently dimensionally stable, and/or do not offer a suitable adherent base for subsequent coatings that are intended to serve, for instance, for protection or stabilisation of the negative (of the result of moulding).

A dehesive coating produced by means of low-pressure plasma polymerisation is known from the state of the art: DE 100 34 737 C2 discloses a plasma-polymeric demoulding layer that possesses dehesive properties, so that the separation of the moulding compound (after curing) from the shape-imparting original is facilitated/enabled. This function is fulfilled by virtue of the fact that although the plasma-polymeric layer possesses outstanding adhesion in relation to the shape-imparting surface it possesses dehesive properties in relation to the moulding composition. This is obtained by virtue of the configuration of the plasma-polymeric layer, which is generated as a gradient layer by temporal variation of the conditions of deposition. With such a coating, metallic moulds (negatives), for example, are coated within the scope of plastics processing, in order to be able to dispense with liquid separating agents. The layer is distinguished, in particular, by the fact that it enables residue-free moulding.

It is a disadvantage of the disclosed coating that the original is changed irrevocably by the coating. Such a change is unacceptable for works of art, for example. In this case, non-contacting processes are currently preferred. Furthermore, the moulded negative is diminished by the volume of the coating (demoulding layer) in relation to the original or—if a negative was firstly generated by way of surface (original) to be moulded, which was subsequently coated with the layer—the positive model resulting after the moulding differs from the original by the corresponding volume. So the coating step ultimately has the result that the moulded product differs additionally from the original. Besides this, there is no possibility of providing the product of the moulding (positive model or negative) merely with a protective coating, for instance, in the course of moulding.

In the case where the original (the surface to be moulded) is moulded classically with moulding compositions it is a disadvantage that the selection of materials is greatly restricted. It follows from this, furthermore, that extremely small surface structures (nanostructures—that is to say, structures within the size-range of 10 nm-500 nm) and the surface properties resulting herefrom cannot be reproduced.

The object of the present invention was to overcome the stated disadvantages of the state of the art. This object is achieved by virtue of a product with a laminated system consisting of at least one covering layer and a moulding layer arranged between the covering layer and the product, the moulding layer being a plasma-polymeric layer that moulds the contours (surface structures) of the product and adheres more firmly to the covering layer than to the product, the product not being a wafer or slice.

In the case of a ‘product’, it is a question, within the scope of this application, of an arbitrary body with a solid surface, the surface of which is to be (at least partially) moulded. Accordingly, a product in the sense of this text may also be a negative of another product that has already been moulded previously. However, it is important for the understanding of this text to realise that a solid body may only represent a product in the sense of this application if its surface had already been formed prior to the coating with the moulding layer. Expressed differently, prior to the coating with the moulding layer and with a covering layer the product must have already existed in its external form (to be moulded) in order to be covered by the term ‘product’ as used here. Wafers and also parts of wafers (slices, dice/dies), particularly those which include electronic components and/or a passivation layer on their surface, are additionally not covered by the term ‘product’.

Products may be, in particular:
Artificial leather and split leather
Optical structures (Fresnel lenses, diffraction gratings, holograms)
Utensils with nanostructuring and easy-to-clean properties.

The covering layer serves to support the moulding layer after separation from the product and, where appropriate, to stabilise it. In the case of the moulding layer, it is a question, according to the invention, of a plasma-polymeric layer, in which connection the process with which this moulding layer was applied is not critical, so long as the composition of the moulding layer and the application process are so chosen that the adhesion of the moulding layer to the covering layer is greater than to the surface of the product. For the purpose of generating the plasma, all methods are possible, ranging from d.c.-voltage excitation to microwave excitation. The use of atmospheric-pressure plasmas is also not excluded.

Production of the plasma-polymeric moulding layer is preferably effected, however, in a low-pressure plasma polymerisation process. With this procedure, special significance is attached to the composition of the gas at the start of the plasma-coating process: an excessive residual oxygen content or an excessive residual moisture content (e.g. from wall coverings) results in a great uncontrolled change in the composition of the gas, and hence in a non-optimal first monolayer of the coating. A non-optimal first monolayer of the coating may also arise when this layer is deposited during the transient phase of the plasma. Therefore it is preferred to establish the necessary general conditions for the deposition of the first monolayer selectively. This may be done, for instance, by sufficient evacuation (two to three powers of ten below the subsequent working pressure), where appropriate assisted by a freezing-out of moisture and/or by thorough heating of the plasma chamber, and/or may also be effected, particularly during the transient phase of the plasma, by temporary masking of the product to be coated (e.g. by a movable screen) in a vacuum. After the transient phase, sufficiently stable conditions prevail, since the residual oxygen content and the residual moisture content in the reactor are greatly reduced by the plasma process. The adhesive properties of the moulding layer in relation to the product are produced, as needed, via the change in the reaction parameters: for instance, gas composition, power and/or pressure. The thickness of the moulding layer amounts preferentially to 1 nm to 1000 nm, more preferably 10 nm to 500 nm, and particularly preferably 50 nm to 200 nm.

A particular advantage of a product according to the invention with a laminated system consists in the fact that, after separation of the laminated system from the product by virtue of the moulding layer remaining on the covering layer, a dimensionally faithful negative, for example, is present which—as is desirable in many cases—includes on its surface a plasma-polymeric layer which, for instance, may assume protective functions. By reason of its dehesive properties in relation to the material of the surface of the moulded product, this layer may also have a positive effect in the course of the production of positive models of this product: if a negative that has been produced is used, for example, for the purpose of generating such positive models, the dehesive properties of the layer may serve, given appropriate choice of the material of the positive model, for assisting the separation of the positive model from the negative.

A product according to the invention with a laminated system is preferred wherein the moulding layer moulds both the macroscopic contour (surface structure) of the product and the nanostructure thereof.

In this connection it is of particular significance that with this moulding it is possible, for the first time, to make nanostructures of a positive transferable. In addition to the macroscopic reproduction of an object, in many cases it may be important to transfer also the nanostructures thereof that bring about, for example, a self-cleaning effect, optical effects or flow effects.

A product according to the invention with a laminated system is preferred wherein the moulding layer is a gradient layer and/or comprises an adhesive zone adjoining the covering layer and a dehesive zone adjoining the product and also, where appropriate, a transition zone, said adhesive zone and said dehesive zone being composed differently as regards material.

Within the scope of the process for deposition of the plasma-polymeric moulding layer it is possible to control the deposition parameters—for example, via the composition of the gas—in such a way that the moulding layer comprises an adhesive zone and a dehesive zone. This is particularly useful when the surface of the product that is to bear, or that bears, the moulding layer possesses adhesion properties that are similar or identical to those of the covering layer being used. Through the appropriate choice of the deposition parameters it is possible to adjust the adhesion properties of the adhesive zone and of the dehesive zone in relation to the layers adjoining the moulding layer (covering layer or surface of the product) precisely. In this connection it is to be stressed that the function of the respective adhesive zone or dehesive zone always relates to the material that rests on the separating layer or on which the separating layer rests. Particularly in the case of the covering layer (which is to be applied later, or which has been applied, as the moulding layer), the ‘adhesive’ property relates, first of all, to the covering layer to be applied in future.

Surprisingly, by means of a deposition process that is conducted in precisely reverse manner in relation to the process described in DE 100 34 737 C2 it is possible for a moulding layer to be obtained that can be employed for the purpose of moulding. Accordingly, in contrast to the process according to DE 100 34 737 C2, the conditions of deposition for the plasma-polymeric moulding layer must be so chosen that the moulding layer with a dehesive zone is deposited on the product (to be moulded). Hence it is guaranteed that the separation between dehesive zone and product can take place after application of a covering layer (onto the last-deposited adhesive zone of the moulding layer).

A product according to the invention with a laminated system, especially in one of the preferred configurations that have been described, is preferred wherein the moulding layer includes on the product side a formerly liquid precursor as an integral constituent.

A particularly good quality for the dehesive properties of the moulding layer can be obtained by the product to be coated being sparsely wetted prior to introduction into the vacuum chamber (in the case of the low-pressure plasma) with a liquid precursor upon which the following demands are made:
In a vacuum it should not evaporate into essential parts.
It should be an active separating substance (e.g. a silicone oil such as AK5 to AK50 produced by Wacker Chemie).

A person skilled in the art will adapt the liquid precursor preferentially to the chemistry of the plasma-polymeric moulding layer, and the precursor should preferably be so thinly applied (e.g. 0.1 nm to 50 nm) that by virtue of the subsequent plasma process the precursor becomes part of the plasma-polymeric coating. In this connection it is particularly preferred that the firstly liquid precursor is completely integrated into the moulding layer. The liquid precursor is preferably applied onto the substrate (the product) by dipping, spraying or spin-coating.

In the first step of the plasma polymerisation the liquid precursor applied in this way is exposed to the active constituents of the plasma (electrons, protons, ions etc.). As a result, both a cross-linking of the precursor molecules amongst themselves (preferably to form the polymer chain or to form a three-dimensional polymer backbone) and also a cross-linking with the layer that is deposited out of the gas phase ordinarily take place. The firstly liquid precursor accordingly becomes an integral constituent of the plasma-polymeric moulding layer and can therefore also subsequently be removed from the product together with said moulding layer.

A person skilled in the art will match the type of the liquid precursor and the thickness of the coating (on the substrate), as well as the following steps of the plasma-polymeric coating, to one another in such a way that an extensive integration, preferably a complete integration, of the firstly liquid precursor into the plasma-polymeric coating occurs. After removal of the moulding layer from the product this can be checked, for example, by contact-angle measurement of the front side of the product. Also with XPS (X-ray photoelectron spectroscopy) it is possible, where appropriate, for precursor residues to be detected on the front side of the product.

A product according to the invention with a laminated system, particularly preferably in one of the preferred configurations that have been described, is preferred wherein the moulding layer can be released from the product in substantially residue-free manner. Such a product according to the invention with a laminated system is particularly preferred wherein the moulding layer can be detached from the product in completely residue-free manner. In order to detach the moulding layer and the covering layer from the product, it may be useful to implement further processing steps with the laminated system consisting of moulding layer and covering layer. For this, a product according to the invention with a laminated system is preferred wherein the moulding layer and the product are capable of being mechanically de-adhered (e.g. by a peeling process), since for many applications mechanical processes are superior to other—for instance, thermal or chemical—processes, particularly because they can be implemented in more surface-conserving manner.

A product according to the invention, especially in one of the preferred configurations that have been described, is particularly preferred wherein the covering layer consists of a polymeric or polymerisable material. In this connection it is preferred, in turn, that the covering layer consists of a lacquer. Such a product is preferentially a sheet. This embodiment is particularly suitable for applying lacquer onto surfaces when the lacquer has already been provided with a plasma-polymeric coating. To this end, a superficially structured sheet is provided with a plasma-polymeric moulding layer, so that the plasma-polymeric moulding layer moulds the contours of the surface of the sheet. Subsequently the moulding layer is wetted with a lacquer. For the purpose of applying the lacquer onto a suitable surface (substrate), the sheet with the plasma-polymeric moulding layer and the not yet completely cured lacquer is then applied on the lacquer side onto the surface to be lacquered, under conditions that enable a (further) curing of the lacquer. Starting from the time from which the lacquer layer adheres more firmly to the moulding layer than the moulding layer adheres to the sheet, it is possible to peel off the sheet from the plasma-polymeric moulding layer. In this connection the lacquer should expediently adhere more firmly to the substrate to be lacquered than the sheet adheres to the moulding layer. After removal of the sheet, a lacquered area remains on the substrate to be lacquered, which additionally includes the plasma-polymeric moulding layer on its surface. This moulding layer bears a negative of the surface of the sheet originally in contact therewith, so that, given an appropriate selection of the sheet, desired surfaces structures of the system consisting of lacquer and moulding layer are capable of being generated easily.

An advantage of such a particularly preferred product according to the invention consists in the fact that a good wetting of the plasma-polymeric moulding layer by the lacquer can be guaranteed already prior to its formation (i.e. prior to the attainment of the appropriate degree of cure of the lacquer). This comes about by selection or control of the properties that the surface of the plasma-polymeric moulding layer possesses on the surface facing towards the lacquer. Further advantages of the particularly preferred subject-matter according to the invention are that the sheet can be easily released from the plasma-polymeric moulding layer, and a protective layer remains on the lacquer.

It is also possible to preserve sheets with a plasma-polymeric moulding layer and with a lacquer layer under conditions that prevent a curing of the lacquer. This may be done, for example, by rolling them up. Of course, further possibilities for preventing a complete polymerisation of the lacquer are known to a person skilled in the art, and he/she will choose the one that is suitable, depending on the application.

Also part of the invention is a process for producing a product according to the invention with a laminated system (preferably in the preferred embodiments described previously), comprising the following steps:
a) making a product available,
b) coating the product with a plasma-polymeric moulding layer, so that the latter adheres to the product,
c) coating the moulding layer with a covering layer, so that the moulding layer adheres more firmly to the covering layer than to the product.

In this connection it is preferred that the moulding layer is deposited on the product in step b), the conditions of deposition being temporally varied in such a way that the moulding layer that is generated is a gradient layer and/or comprises an adhesive zone for the purpose of applying the covering layer and a dehesive zone adjoining the product and also, where appropriate, a transition zone.

In this connection the product is preferably wetted prior to or in step b) with a liquid precursor which again is preferentially an active separating substance, in order in this way to influence the separating properties of the dehesive zone of the moulding layer in desired manner. In a process according to the invention it is preferred that the liquid precursor is applied onto the product by means of dipping, spraying or a spin-coating process. In quite particularly preferred manner the process according to the invention is implemented in step b) in such a way that the liquid precursor is cross-linked and becomes an integral constituent of the moulding layer.

In this way, most of the disadvantages of the contemporary casting compounds can be overcome or corrected by the invention.

Also part of the invention is a process for producing a negative that moulds (i) parts of the surface or (ii) the surface of a product, comprising the following steps:
a) making available a product according to the invention with a laminated system (as characterised above),
b) separating the laminated system from the product, so that the separated laminated system is a negative that moulds (i) parts of the surface or (ii) the surface of the product.

Products of any type (technical, biological or artistic) can be moulded. In this connection, in accordance with the procedure in the process according to the invention the moulding layer is detached (preferably completely) in residue-free manner from the object for shaping (the product), and imparts to the negative a dehesive surface in relation to materials that in their adhesion/dehesion properties resemble the surface material of the moulded product.

In this connection the process according to the invention for producing a moulding negative has the advantage not only that the negative can be separated from the shaping positive in residue-free manner, but that in the case where use is made of a plasma-polymeric gradient layer by way of moulding layer there is a considerably greater freedom with respect to the selection of the materials that are intended to form the covering layer. Hence it is possible for the properties of the negative to be influenced, since the conditions of deposition for the moulding layer can be so chosen that the adhesive zone has been adapted to the desired material for the covering layer (i.e. it adheres at least more firmly thereto than to the product to be moulded). At the same time, the dehesive properties with regard to the surface of the moulding layer to be moulded depend only on the conditions in the initial phase of the deposition of the moulding layer (and, where appropriate, on an appropriate precursor pretreatment). In this connection it is to be borne in mind that the dehesive zone represents the surface of the negative after the separation from the product to be moulded, and characterises said surface in its adhesive (dehesive) properties. Furthermore, nanostructures can also be reproduced by means of the plasma-polymeric moulding layer, provided that they are not present in the form of cavities or undercuts (e.g. lotus-leaf surfaces). The construction of mechanically and thermally stable negatives also becomes possible. The longevity of the negatives is improved considerably: ‘flow’ is forestalled. It is also to be noted that in the case where the product to be moulded already itself represents a negative (of an original product) the moulding negative (in the form of a ‘double’ negative) that is generated with the process according to the invention for producing a moulding negative represents a positive model (or a part thereof of the original product.

The process according to the invention for producing a moulding negative can be employed in the technical field of embossing: here it is again particularly advantageous if, simultaneously with the embossing operation, a dehesive coating (where appropriate, combined with a further functional coating such as, for example, a barrier coating) is transferred from the embossing tool, which here corresponds to a ‘product with a laminated system’, onto the material to be embossed, which here analogously then constitutes the negative.

Also part of the invention is a process for producing a positive model of (i) parts of the surface or (ii) the surface of a product, comprising the following steps:
a) producing a moulding negative of (i) parts of the surface or (ii) the surface of the product by means of a process as previously described,
b) moulding the negative, so that the positive model is formed.

In this connection, step b) may also preferably be implemented several times. Moulding of the negative may be effected, for instance, by pouring-out, injection moulding or dipping; in this connection it is self-evident that by means of a process according to the invention the moulding of undercuts is only possible with great difficulty or is not possible at all (this also applies to the creation of negatives, described previously).

The second variant of the process according to the invention for producing a moulding negative can also be employed in the technical process of embossing. In this connection it is advantageous that the negative (in the form of an embossing punch) includes as outermost layer the plasma-polymeric moulding layer (with its dehesive properties outwards). Given appropriate choice of material for the surface of the positive model to be embossed, the separation of negative and positive model is facilitated in this case; expressed differently, the material to be embossed (surface of the positive model) possesses low adhesion in relation to the embossing punch (negative).

Also part of the invention is a process for producing a positive model of (i) parts of the surface or (ii) of the surface of a product, comprising the following steps:
a) producing a negative that moulds (i) parts of the surface or (ii) the surface of the product,
b) coating the negative with a moulding layer which is a plasma-polymeric layer that moulds the contours of the negative,
c) coating the moulding layer with a backing layer, whereby the moulding layer adheres more firmly to the backing layer than to the negative,
d) separating the backing layer from the negative, so that the moulding layer remains on the backing layer and the laminated system consisting of backing layer and moulding layer forms the positive model.

In this connection it is preferred that after step c) the coated negative is a product according to the invention with a laminated system (preferably in one of the embodiments previously described), wherein the backing layer corresponds to the covering layer.

A particular advantage of this process consists in the fact that the positive model generated thereby bears on its surface the moulding layer which, depending on the configuration, may serve, for instance, as a protective layer, for instance against soiling, diffusion of water, and mechanical damage.

The last-described process according to the invention can also be employed in the technical field of embossing: here it is again particularly advantageous if, simultaneously with the embossing operation, a dehesive coating (where appropriate, combined with a further functional coating such as, for example, a barrier coating) is transferred from the embossing tool, which here is itself a negative, onto the material to be embossed, which then correspondingly forms the positive model.

Preferred is a process according to the invention for producing a positive model of (i) parts of the surface or (ii) the surface of a product, the steps of which comprise
a) accordingly the production of a negative that moulds (i) parts of the surface or (ii) the surface of the product,
b) coating the negative with a moulding layer which is a plasma-polymeric layer that moulds the contours of the negative,
c) coating the moulding layer with a backing layer, whereby the moulding layer adheres more firmly to the backing layer than to the negative,
d) separating the backing layer from the negative, so that the moulding layer remains on the backing layer and the laminated system consisting of backing layer and moulding layer forms the positive model,
   step a) comprising the following steps:
making available a product according to the invention with a laminated system (preferably in a variant described above as preferred),
   separating the laminated system from the product, so that the separated laminated system is a negative that moulds (i) parts of the surface or (ii) the surface of a product, whereby preferably after step c) the coated negative represents a product according to the invention with a laminated system (again preferably in one of the embodiments described above as preferred).

The configurations of the process according to the invention described in the last section have the advantage that: 1. use is made of an optimally adapted negative, since the latter includes on its surface a plasma-polymeric moulding layer; and 2. the positive model includes a second plasma-polymeric moulding layer.

On the basis of the comments made above, further fields of application for the processes according to the invention are opened up to a person skilled in the art. As examples, the following may be mentioned:
injection moulding; production of injection-moulded structural components with a permanent dehesive coating (moulding coating)
the reproducing/moulding of works of art without changing the latter themselves
the moulding of biological surfaces; for example, leaf surfaces
replacement of the wax coating in the case of embossed sheets
production of easy-to-clean or soiling-resistant split leather or artificial-leather surfaces.

The invention will be elucidated below on the basis of the appended Figures.

Represented are:

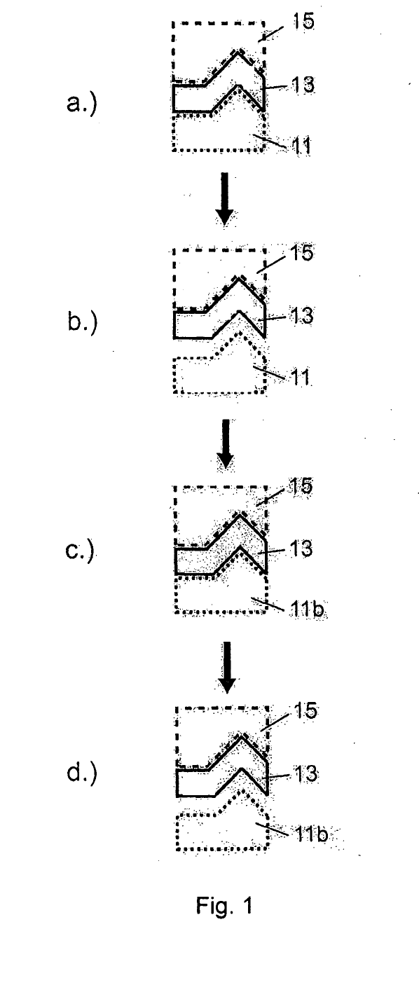

FIG. 1: a schematic representation of a process according to the invention for producing a positive model of (i) parts of the surface or (ii) the surface of a product;

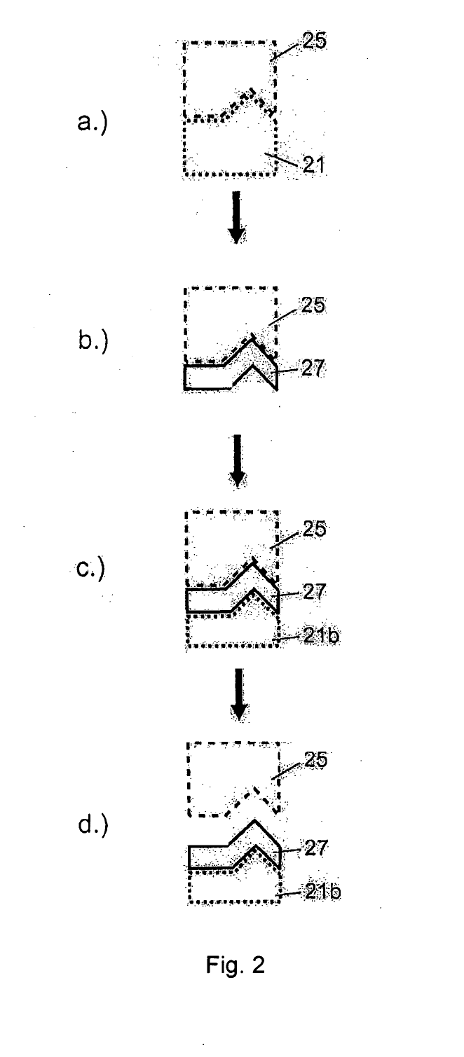

FIG. 2: a schematic representation of a process according to the invention for producing a positive model of (i) parts of the surface or (ii) the surface of a product, wherein a laminated system consisting of backing layer and moulding layer forms the positive model;

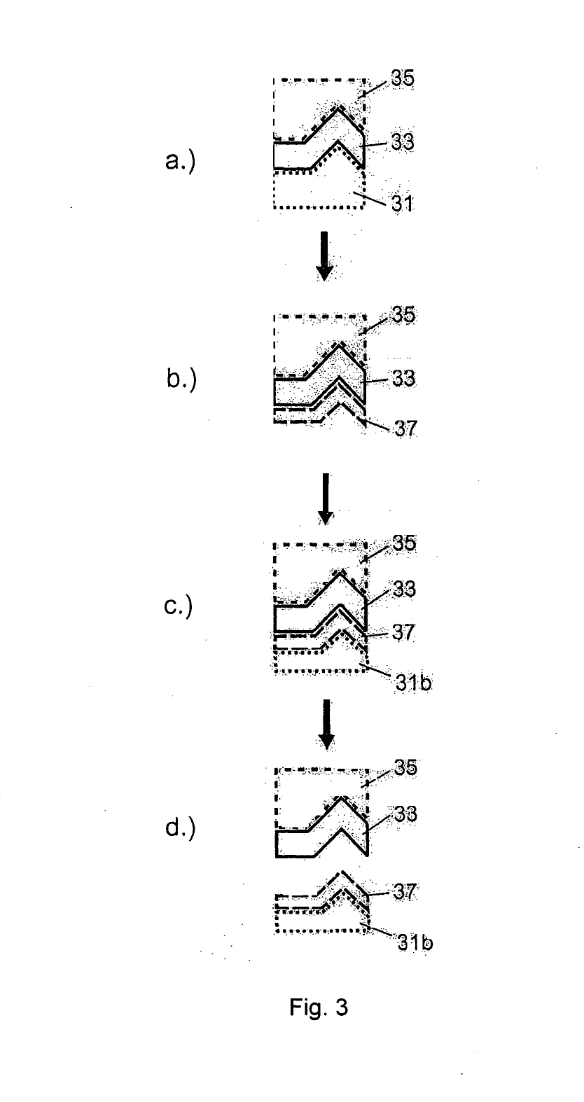

FIG. 3: a further process for producing a positive model of (i) parts of the surface or (ii) the surface of a product, wherein a laminated system consisting of backing layer and moulding layer forms the positive model.

### DETAILED DESCRIPTION OF THE FIGURES

FIG. 1a) represents a product (with surface to be moulded) 11, with a laminated system consisting of a moulding layer 13 and a backing layer or covering layer 15, wherein the moulding layer 13 adheres more firmly to the backing layer or covering layer 15 than to the product 11.

FIG. 1b) represents the laminated system consisting of the moulding layer 13 and the backing layer or covering layer 15 after separation from the product 11. The laminated system consisting of moulding layer 13 and backing layer or covering layer 15 jointly forms the moulding negative of the product 11.

FIG. 1c) represents the moulding of the moulding negative 13, 15 by means of a material 11b to be shaped. FIG. 1c) may, for instance, also represent an embossing operation.

FIG. 1d) represents the moulding negative 13, 15 which has been separated from the moulded positive model 11b. The positive model 11b corresponds in its surface structure to the product 11 (applies to the moulded region).

FIG. 2a) represents a product (with surface to be moulded) 21 and a negative 25 which takes on the structure from the surface of the product.

FIG. 2b) represents the structured, moulding negative 25 which is coated with a moulding layer 27 which takes on the structure.

FIG. 2c) represents the laminated system consisting of structured, moulding negative 25, structured moulding layer 27 and backing layer or covering layer 21b, wherein the moulding layer 27 adheres more firmly to the backing layer or covering layer 21b than to the moulding negative 25.

FIG. 2d) represents the moulding negative 25 after it has been separated from the positive model formed, which is formed from structured moulding layer 27 and backing layer or covering layer 21b. The process shown in FIGS. 2a- 2d can be controlled in such a way that the positive model 21b, 27 corresponds exactly to the spatial extent of the product 21.

FIG. 3a) represents a product (with surface to be moulded) 31 with a laminated system consisting of moulding layer 33 and backing layer or covering layer 35, wherein the moulding layer 33 adheres more firmly to the backing layer or covering layer 35 than to the product 31.

FIG. 3b) represents the laminated system consisting of the backing layer or covering layer 35 and the moulding layer 33 by way of moulding negative of the product 31, wherein the negative has, in turn, been coated with a second moulding layer 37, wherein the moulding layer 33 adheres more firmly to the backing layer or covering layer 35 than to the second moulding layer 37.

FIG. 3c) represents the moulding negative, consisting of backing layer or covering layer 35 and moulding layer 33, which is coated with the second moulding layer 37, wherein the latter has, in turn, been coated with moulding material 31b in such a way that the second moulding layer 37 adheres more firmly to the moulding material 31b than to the moulding layer 33.

FIG. 3d) represents the positive model of the product 31, which is formed from the moulding material 31b and from the second moulding layer 37, and, separately therefrom, the moulding negative of the product 31, which is formed from the moulding layer 33 and the backing layer or covering layer 35. In this connection the process shown in FIGS. 3a-3d can be controlled in such a way that the positive model 37, 31b corresponds exactly to the spatial extent of the product 31.

1. A product with a laminated system consisting of at least one covering layer and a moulding layer arranged between the covering layer and the product, characterised in that the moulding layer is a plasma-polymeric layer that moulds the contours of the product and adheres more firmly to the covering layer than to the product, the product not being a wafer or die.

2. Product with a laminated system according to claim 1, wherein the moulding layer moulds both the macroscopic contour of the product and the nanostructure thereof.

3. Product with a laminated system according to claim 1, wherein the moulding layer is a gradient layer and/or comprises an adhesive zone adjoining the covering layer and a dehesive zone adjoining the product and also, where appropriate, a transition zone, said adhesive zone and said dehesive zone being composed differently as regards material.

4. Product with a laminated system according to claim 1, wherein the moulding layer includes on the product side a formerly liquid precursor as an integral constituent.

5. Product with a laminated system according to claim 1, wherein the moulding layer can be released from the product in substantially residue-free manner.

6. Product with a laminated system according to claim 1, wherein the moulding layer and the product are capable of being mechanically de-adhered.

7. Product with a laminated system according to claim 1, wherein the covering layer consists of a polymeric or polymerisable material.

8. Product with a laminated system according to claim 7, wherein the covering layer consists of a lacquer.

9. Product with a laminated system according to claim 7, wherein the product is a sheet.

10. A process for producing a product with a laminated system according to claim 1, comprising the following steps:
a) making a product available,
b) coating the product with a plasma-polymeric moulding layer, so that the latter adheres to the product,
c) coating the moulding layer with a covering layer, so that the moulding layer adheres more firmly to the covering layer than to the product.

11. Process according to claim 10, wherein in step b) the moulding layer is deposited onto the product, the conditions of deposition being temporally varied in such a way that the moulding layer which is generated is a gradient layer and/or comprises an adhesive zone for the purpose of applying the covering layer and a dehesive zone adjoining the product and also, where appropriate, a transition zone.

12. Process according to claim 10, wherein the product is wetted with a liquid precursor prior to or in step b).

13. Process according to claim 12, wherein the liquid precursor is an active separating substance.

14. Process according to claim 12, wherein step b) is implemented in such a way that the liquid precursor is cross-linked and becomes an integral constituent of the moulding layer.

15. A process for producing a negative that moulds at least part of the surface of a product, comprising the following steps:
a) making available a product with a laminated system according to claim 1,
b) separating the laminated system from the product, so that the separated laminated system is a negative that moulds at least part of the surface of the product.

16. A process for producing a positive model of at least part of the surface of a product, comprising the following steps:
a) producing a moulding negative of at least part of the surface of the product by means of a process according to claim 15,
b) moulding the negative, so that the positive model is formed.

17. A process for producing a positive model of at least part of the surface of a product, comprising the following steps:
a) producing a negative that moulds said part of the surface of the product,
b) coating the negative with a moulding layer which is a plasma-polymeric layer that moulds the contours of the negative,
c) coating the moulding layer with a backing layer, the moulding layer adhering more firmly to the backing layer than to the negative,
d) separating the backing layer from the negative, so that the moulding layer remains on the backing layer and the laminated system consisting of backing layer and moulding layer forms the positive model.

18. A process for producing a positive model of at least part of the surface of a product, comprising the following steps:
a) producing a negative that moulds said part of the surface of the product,
b) coating the negative with a moulding layer which is a plasma-polymeric layer that moulds the contours of the negative,
c) coating the moulding layer with a backing layer, the moulding layer adhering more firmly to the backing layer than to the negative,
d) separating the backing layer from the negative, so that the moulding layer remains on the backing layer and the laminated system consisting of backing layer and moulding layer forms the positive model; and
wherein after step c) the coated negative is a product with a laminated system according to claim 1, wherein the backing layer corresponds to the covering layer.

19. A process for producing a positive model of at least part of the surface of a product, comprising the following steps:
a) producing a negative that moulds said part of the surface of the product,
b) coating the negative with a moulding layer which is a plasma-polymeric layer that moulds the contours of the negative,
c) coating the moulding layer with a backing layer, the moulding layer adhering more firmly to the backing layer than to the negative,
d) separating the backing layer from the negative, so that the moulding layer remains on the backing layer and the laminated system consisting of backing layer and moulding layer forms the positive model: and
said a) step further comprising:
making available a product with a laminated system according to claim 1,
separating the laminated system from the product, so that the separated laminated system is a negative that moulds at least part of the surface of the product.

20. Product with a laminated system according to claim 2, wherein:
the moulding layer is a gradient layer and/or comprises an adhesive zone adjoining the covering layer and a dehesive zone adjoining the product and also, where appropriate, a transition zone, said adhesive zone and said dehesive zone being composed differently as regards material;
wherein the moulding layer includes on the product side a formerly liquid precursor as an integral constituent;
the moulding layer can be released from the product in substantially residue-free manner;
the moulding layer and the product are capable of being mechanically de-adhered;
the covering layer consists of a polymeric or polymerisable material;
the covering layer consists of a lacquer;
the product is a sheet.

21. A process for producing a product with a laminated system according to claim 20, comprising the following steps:
a) making a product available,
b) coating the product with a plasma-polymeric moulding layer, so that the latter adheres to the product,
c) coating the moulding layer with a covering layer, so that the moulding layer adheres more firmly to the covering layer than to the product.

22. Process according to claim 21, wherein:
in step b) the moulding layer is deposited onto the product, the conditions of deposition being temporally varied in such a way that the moulding layer which is generated is a gradient layer and/or comprises an adhesive zone for the purpose of applying the covering layer and a dehesive zone adjoining the product and also, where appropriate, a transition zone;
the product is wetted with a liquid precursor prior to or in step b);
the liquid precursor is an active separating substance;
step b) is implemented in such a way that the liquid precursor is cross-linked and becomes an integral constituent of the moulding layer.

23. A process for producing a negative that moulds at least part of the surface of a product, comprising the following steps:
a) making available a product with a laminated system according to claim 21,
b) separating the laminated system from the product, so that the separated laminated system is a negative that moulds at least part of the surface of the product.

24. A process for producing a positive model of at least part of the surface of the product, comprising the following steps:
a) producing a moulding negative of at least part of the surface of the product by means of a process according to claim 23,
b) moulding the negative, so that the positive model is formed.

25. A process for producing a positive model of at least part of the surface of a product, comprising the following steps:
a) producing a negative that moulds said part of the surface of the product,
b) coating the negative with a moulding layer which is a plasma-polymeric layer that moulds the contours of the negative,
c) coating the moulding layer with a backing layer, the moulding layer adhering more firmly to the backing layer than to the negative,
d) separating the backing layer from the negative, so that the moulding layer remains on the backing layer and the laminated system consisting of backing layer and moulding layer forms the positive model; and
wherein after step c) the coated negative is a product with a laminated system according to claim 6, wherein the backing layer corresponds to the covering layer.

26. A process for producing a positive model of at least part of the surface of a product, comprising the following steps:
a) producing a negative that moulds said part of the surface of the product,
b) coating the negative with a moulding layer which is a plasma-polymeric layer that moulds the contours of the negative,
c) coating the moulding layer with a backing layer, the moulding layer adhering more firmly to the backing layer than to the negative,
d) separating the backing layer from the negative, so that the moulding layer remains on the backing layer and the laminated system consisting of backing layer and moulding layer forms the positive model;
wherein after step c) the coated negative is a product with a laminated system according to claim 20, wherein the backing layer corresponds to the covering layer; and
said a) step further comprising:
making available a product with a laminated system according to claim 20,
separating the laminated system from the product, so that the separated laminated system is a negative that moulds at least part of the surface of the product.
